(19) United States
(12) Patent Application Publication
(10) Pub. No.: US 2002/0063181 A1
(43) Pub. Date: May 30, 2002

(54) Double bearing type fishing reel

(75) Inventor: Nobuyuki Yamaguchi, Tokyo (JP)

Correspondence Address: SUGHRUE MION, PLLC, 2100 Pennsylvainia Avenue, NW, Washington, DC, 20037-3213, US

(73) Assignee: DAIWA SEIKO, INC

(21) Appl. No.: 09/987,138

(22) Filed: Nov. 13, 2001

(30) Foreign Application Priority Data
Nov. 10, 2000 (JP) P2000-344215

(51) Int. Cl. A01K 89/02

(52) U.S. Cl. 242/286; 242/288

(57) ABSTRACT

The present invention provides a double bearing type fishing reel (1) including a spool (3) rotatably supported between side plates (1a, 1b) of a reel main body, a fishing line wound around the spool (3), and an antibacklash mechanism (20) for imparting braking force to rotation of the spool (3) for preventing excessive rotation of the spool (3) in a direction in which the fishing line is thrown, wherein an area of the side plate (1a) of the reel main body, which can be at least gripped and held, also doubles as an adjustment operation portion (41) for adjusting the braking force imparted by the antibacklash mechanism (20).

### BACKGROUND OF THE INVENTION

The present invention relates to a double bearing type fishing reel, and more particularly, to a double bearing type fishing reel having an antibacklash mechanism for preventing occurrence of a line-entanglement phenomenon (e.g., a backlash phenomenon) when a fishing line is paid out (e.g., at the time of casting).

A double bearing type fishing reel has usually been equipped with a brake, called an antibacklash mechanism, for preventing occurrence of a backlash phenomenon, which would otherwise be caused by excessive rotation of a spool when terminal tackle is thrown (i.e., at the time of casting action) Various types of brakes, such as a friction brake utilizing centrifugal force and a magnetic brake utilizing magnetic force, have been known as such an antibacklash mechanism.

The antibacklash mechanism is usually equipped with a braking force adjustment portion which enables adjustment of braking force in accordance with the skill of an angler and the leap of terminal tackle. The braking force adjustment portion is usually mounted outside a reel main body. In general, an operation portion to be used for adjusting braking force projects from a side plate of the reel main body.

In the case that the operation portion of the braking force adjustment portion projects from the side plate of the reel main body, an angler obtains an unusual feeling in the hands when gripping and holding a reel with the palm. Use of such a reel for several hours may result in pain in the hand. One possible measure for preventing the presence of an operation portion from hampering holding of a reel is imposing limitations on the position from which the operation portion is to project (i.e., a mounting position). In this case, the degree of design freedom is reduced.

Further, in the case that the operation portion of the braking force adjustment portion projects from the side plate of the reel main body, the hand holding the reel will touch the operation portion of the braking force adjustment portion, thereby resulting in erroneous operation. In order to prevent occurrence of such an erroneous operation, the braking force adjustment portion must have strong retaining force, thereby requiring an increase in the force required for operating the operation portion. Particularly, when the operation portion of the braking force adjustment portion is small, a fingernail would be hurt if the operation portion is rotated by the fingernail. Also, a finger tip would be hurt when forcefully pressed against the operation portion. Thus, an urgent improvement is required.

### SUMMARY OF THE INVENTION

The present invention has been conceived against the foregoing objects and aims at providing a double bearing type fishing reel equipped with an antibacklash mechanism which prevents occurrence of an unusual feeling in the hands, which would otherwise be caused when an angler grips and holds a reel with the palm; requires small operation force for actuating a braking force adjustment portion; and involves only a small possibility of occurrence of erroneous operation.

In order to solve the aforesaid object, the invention is characterized by having the following arrangement.

(1) A double bearing type fishing reel comprising:

a reel main body including side plates opposed each other;

a spool, for winding a fishing line thereon, rotatably supported between the side plates; and

an antibacklash mechanism for applying braking force to rotation of the spool for preventing excessive rotation of the spool in a direction in which the fishing line is paid out,

wherein a portion of one of the side plates, which can be at least gripped and held by a hand, functions as an adjustment operation portion for adjusting the braking force applied by the antibacklash mechanism.

(2) The double bearing type fishing reel according to (1), wherein

an exterior surface of the adjustment operation portion is substantially flush with an exterior surface of the other portion of the one of the side plates, and

the one of the side plates including the adjustment operation portion has a smooth shape not having any portion projecting from the exterior surface of the one of the side plate.

(3) The double bearing type fishing reel according to (2), wherein the entirety of the one of the side plates including the adjustment operation portion has a spherical shape bulging in a rotating axis direction of the spool.

(4) The double bearing type fishing reel according to (1), wherein the side plate having the adjustment operation portion is a circular shape in view from the rotating axis direction, and the adjustment operation portion is located substantially concentrically with the reel main body.

(5) The double bearing type fishing reel according to (1), wherein the one of the side plates includes the adjustment operation portion and a support portion for supporting the spool, the adjustment operation being capable of rotating with respect to the support portion for adjusting the braking force.

### BRIEF DESCRIPTION OF THE DRAWINGS

FIG. 1 is a cross-sectional view of a double bearing type fishing reel according to a first embodiment of the present invention;

FIG. 2 is an enlarged cross-sectional view showing the principal portion of the double bearing type fishing reel shown in FIG. 1;

FIG. 3 is a cross-sectional view of a braking portion of an antibacklash mechanism in the double bearing type fishing reel shown in FIG. 1;

FIG. 4 is a cross-sectional view of a braking force adjustment portion of an antibacklash mechanism in the double bearing type fishing reel shown in FIG. 1; and

FIG. 5 is a left-side view of the double bearing type fishing reel shown in FIG. 1.

### DETAILED DESCRIPTION OF PREFERRED EMBODIMENTS

An embodiment of the present invention will be described hereinbelow by reference to the accompanying drawings.

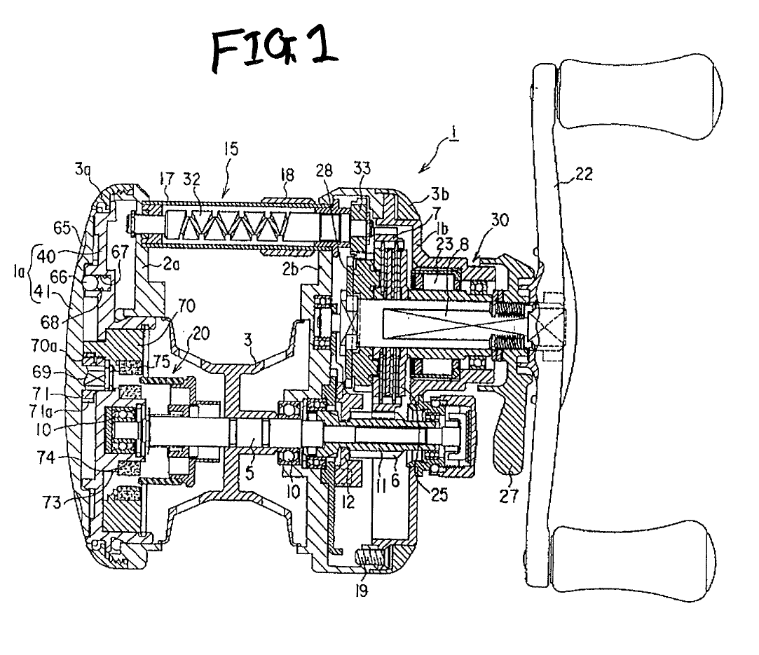

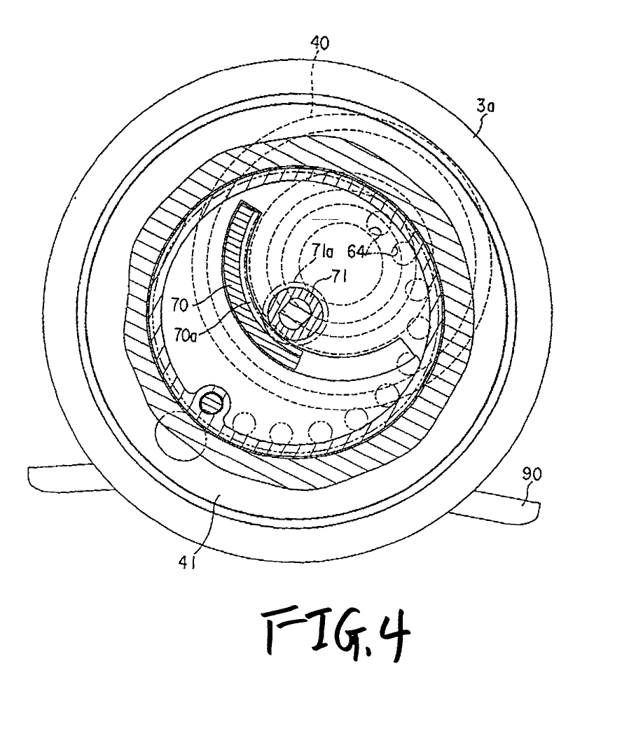

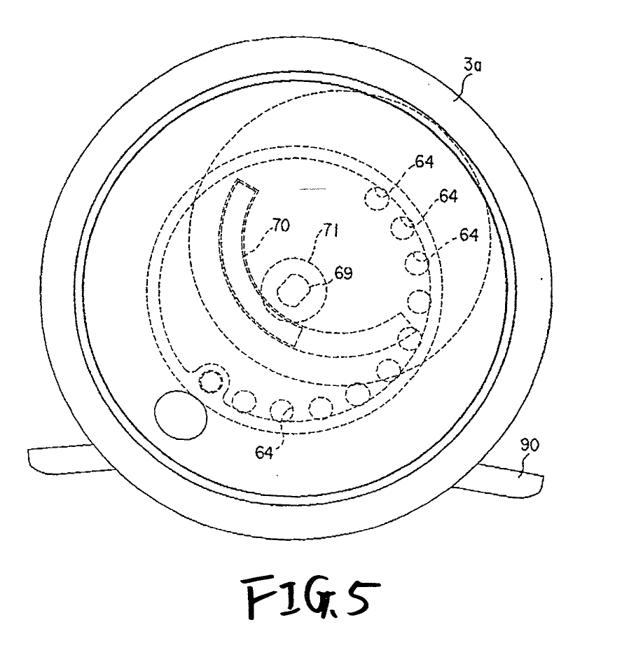

As shown in FIG. 1, a double bearing type fishing reel 1 according to the present embodiment comprises a spool 3 around which a fishing line is to be wound, and a reel main body for rotatably supporting the spool 3. The reel main body comprises frames 2a and 2b located to opposite side of the spool 3, respectively, a left side plate 1a attached to the frame 2a, and a right side plate 1b attached to the frame 2b. Provided on the reel main body is a rod attachment 90 (see FIGS. 4 and 5) which is to be removably attached to a reel seat of a fishing rod.

Each of the side plates 1a and 1b is constituted so as to assume a circular shape (i.e., a round shape when viewed from the side). The side plates 1a and 1b are attached to the frames 2a and 2b, respectively, by means of screw engagement or fitting engagement. As illustrated, when the side plates 1a and 1b are attached to the frames 2a and 2b through use of a screw 19, a ring-shaped member 3a is attached to the rim of the side plate la so as to hide the screw 19, with another ring-shaped member 3b being attached to the rim of the side plate 1b.

The right side plate 1b located on the right side in the drawing supports a winding drive portion 30 for rotationally driving the spool 3. The right frame 2b located on the right side in the drawing rotatably supports one end of a spool shaft 5 through a shaft bearing 10. Further, a given space is defined between the right frame 2b and the right side plate 1b. Various mechanisms constituting the winding drive portion 30, such as a driving force transmission system and a dragging system, are housed in the space.

The left side plate la located on the left side in the drawing comprises an inner support portion 40 and an outer adjustment operation portion 41. The inner support portion 40 rotatably supports the other end of the spool shaft 5 through the bearing 10 and a part of the antibacklash mechanism 20 (described later). The outer adjustment operation portion 41 opposes the support portion 40 and doubles as an operation portion of a braking force adjustment portion of the antibacklash mechanism 20; the operation portion will be described later. In this case, an exterior surface of the left side plate la is constituted by an exterior surface of the adjustment operation portion 41 and the rim of the support portion 40. The adjustment operation portion 41 assumes a substantially circular shape (i.e., a round geometry) when viewed from the side, so as to smoothly bulge sideways in the form of a spherical profile. The adjustment operation portion 41 constitutes the major exterior surface of the left side plate 1a and is located concentrically with the reel main body. The surface of the rim of the support portion 40 is connected to the exterior surface of the adjustment operation portion 41 without steps.

The spool shaft 5 rotatably supported through the bearings 10, 10 extends across the frames 2a and 2b. A pinion gear 6 that is axially movable along the spool shaft 5 is attached to the end of the spool shaft 5 projecting from the right frame 2b. In this case, the pinion gear 6 is rotatably supported by a pinion shaft 11. By means of unillustrated switching member, the pinion gear 6 is moved between an engagement position in which the pinion gear 6 engages with and rotates along with the spool shaft 5, and a disengagement position in which the pinion gear 6 is disengaged from the spool shaft 5. More specifically, a circumferential groove to be engaged with a clutch plate 12 is formed in the pinion gear 6. The clutch plate 12 can move along the pinion shaft 11 by means of an unillustrated coupling mechanism and is actuated as a result of operation of an unillustrated clutch switching member. More specifically, the pinion gear 6 is moved rightward from the position shown in FIG. 1 through the clutch plate 12 and is then disengaged from the spool shaft 5 (in a clutch OFF position) Consequently, the spool 3 becomes freely rotatable.

A drive gear 7 meshes with the pinion gear 6, and a handle shaft 8 constituting the winding drive portion 30 is attached to the drive gear 7. More specifically, the handle shaft 8 and the drive gear 7 which is to mesh with the pinion gear 6 are rotatably supported by the support side plate 1b. A handle 22 constituting the winding drive portion 30 along with the handle shaft 8 is attached to an outer end portion of the handle shaft 8. Consequently, when the handle 22 is rotated, the spool shaft 5 is rotationally driven via the drive gear 7 and the pinion gear 6. The spool 3 is rotated in association with rotation of the spool shaft 5.

A one-way clutch 23 which enables one-way rotation of the handle shaft 8 is provided at any point along the handle shaft 8. A friction plate 25 (drag mechanism) which is to engage with the drive gear 7 is provided at an inner end of the handle shaft 8. As a result of rotation of a drag operation member 27 provided on the handle 22, the friction plate 25 is pressed axially and is frictionally engaged with the drive gear 7, thus applying dragging action.

A gear 28 is provided at an inner end of the handle shaft 8. The gear 28 is coupled to the drive gear 7 and rotates integrally with the same. The gear 28 is engaged with a drive gear 33 which drives a wormshaft 32 of a level wind mechanism 15 disposed forward of the spool 3. The level wind mechanism 15 includes the worm shaft 32, a sleeve 17 for housing the wormshaft 32, and an engagement member 18. A traverse groove is formed on the outer peripheral surface of the worm shaft 32. The drive gear 33 is attached to the end of the wormshaft 32. The engagement member 18 is engaged with the traverse groove and travels horizontally along the sleeve 17 according to rotation of the wormshaft 32. The level wind mechanism 15 guides a fishing line wound around the spool 3 through a hole formed in the engagement member 18. Consequently, when the handle 22 is rotated, the fishing line is evenly wound around the spool 3 by means of rotation of the spool 3 and horizontal sliding action of the engagement member 18.

The antibacklash mechanism 20, for preventing occurrence of backlash by means of controlling excessive rotation of the spool 3, is provided at the end of the spool shaft 5 in the vicinity of the left frame 2a, which would otherwise be caused when a fishing line is unreeled. The antibacklash mechanism 20 is constituted by a braking portion for applying braking force to rotation of the spool 3, and a braking force adjustment portion for adjusting braking force.

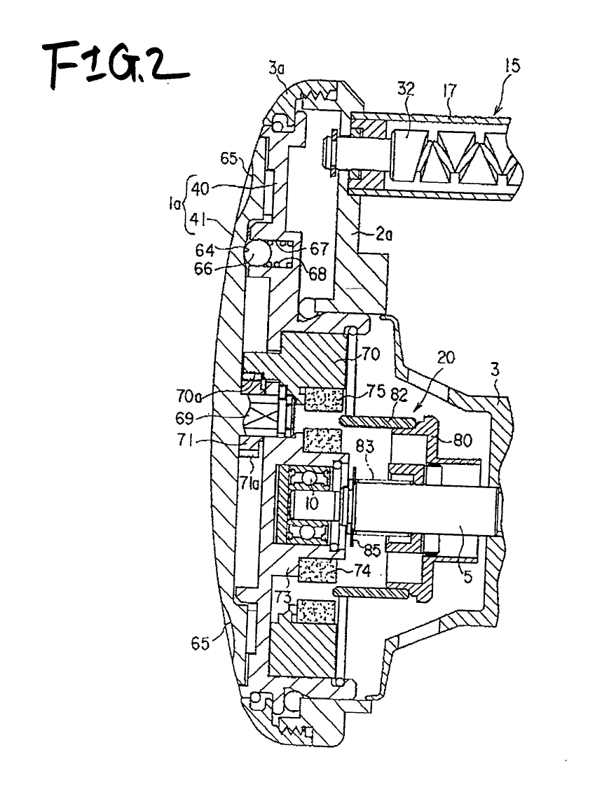

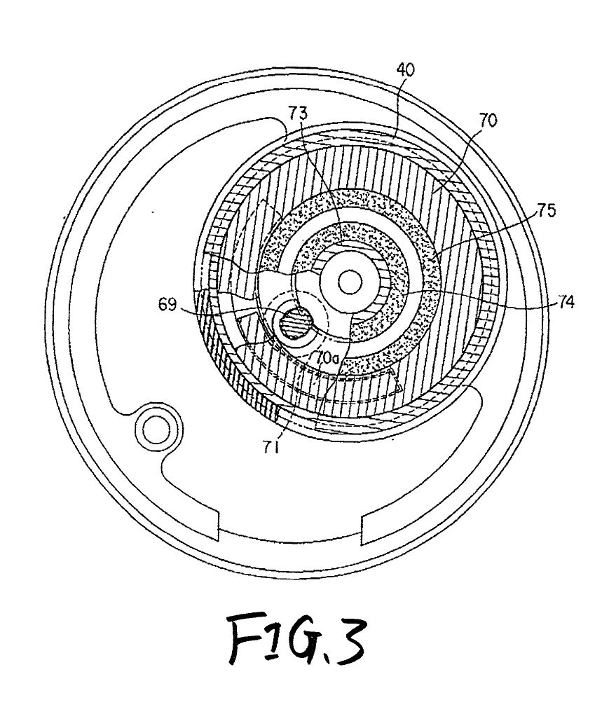

As shown in an enlarged manner in FIG. 2, the braking portion of the antibacklash mechanism 20 is constituted by a pair of annular magnets 74, 75 and an annular conductor 82 to be removably inserted into an annular space defined between the magnets 74, 75 (see FIG. 3). More specifically, an annular magnet holder 70 is rotatably retained by the support portion 40. The annular external magnet 75 is fixed to an inner peripheral surface of the magnet holder 70. A projecting retaining portion 73 is formed in the support portion 40. The projecting retaining portion 73 opposes to the magnet holder 70 and retains the bearing 10. The annular inner magnet 74 is fixed to an outer peripheral surface of the projecting retaining portion 73 so as to oppose to the outer magnet 75.

The conductor 82 is fixed to a moving element 80 movably attached to the outer periphery of the spool shaft 5. In this case, the conductor 82 extends along the axial direction of the spool shaft 5 so as to oppose to the annular space defined between the magnets 74 and 75 and to be removably inserted into the annular space. A compression spring 83 is interposed between a retainer 85 fixed to the end of the spool shaft 5 and the moving element 80 so that he compression spring 83 is wound around the outer peripheral surface of the spool shaft 5 and constantly applies pressing force to the moving element 80 toward the spool shaft 3 such that the moving element 80 departs from the retainer 85.

The braking force adjustment portion of the antibacklash mechanism 20 includes the adjustment operation portion 41 constituting the left side plate 1a. A shaft portion 69 is provided in the center of the adjustment operation portion 41 so as to protrude inward toward the support portion 40 substantially in parallel with the spool shaft 5. A gear 71 is attached and fixed to the shaft portion 69. Inner teeth 70a are formed in a portion of the magnet holder 70, the portion extending in parallel with and opposing to the shaft portion 69. The inner teeth 70a mesh with outer teeth 71a of the gear 71. Therefore, when the gear 71 is rotated by means of rotationally operating the adjustment operation portion 41, the magnet holder 70 meshing with the gear 71 is rotated, so that the outer magnet 75 fixed to the magnet holder 70 rotates relative to the inner magnet 74. A plurality of concaves 65 which are of a size sufficient to enable resting of a finger for rotating the adjustment operation portion 41 are formed in the vicinity of the rim of exterior surface of the adjustment operation portion 41.

The antibacklash mechanism 20 is equipped with a clicking mechanism for retaining a relative rotational position of the adjustment operation portion 41 with respect to the support portion 40 (a relative position of the outer magnet 75 with respect to the inner magnet 74) while permitting rotation of the adjustment operation portion 41 relative to the support portion 40. The clicking mechanism has a plurality of recesses 64 formed in an interior surface of the adjustment operation portion 41 and a spherical portion 66 which is to removably engage with one of the recesses 64. The recesses 64 are provided at predetermined intervals in the circumferential direction of the adjustment operation portion 41 (see FIGS. 4 and 5). The spherical portion 66 is housed in a hole 67 formed in the support portion 40 and is pushed with constant force toward a direction in which the spherical portion 66 is to engage with the recess 64, by a coil spring 68 provided in the hole 67.

The operation of the antibacklash mechanism 20 having the foregoing configuration will now be described.

When the spool 3 is rotated by operating the handle 22, the moving element 80 rotates integrally with the spool 3 through the spool shaft 5. By utilizing centrifugal force generated due to rotation of the spool shaft 3, an unillustrated collar, for example, moves in an outer radial direction so as to apply pressing force on the moving element 80. When the rotational speed of the spool 3 has reached a predetermined level and the pressing force applied on the moving element 80 from the collar has surpassed the force imparted by the compression spring 83, the moving element 80 starts moving toward the left side plate 1a along the spool shaft 5. When the conductor 82 is inserted into the annular space (i.e., magnetic field) defined between the magnets 74 and 75 as a result of movement of the moving element 80, the moving element 80 having the conductor 82 is subjected to force from the magnetic field, the force corresponding to the extent of insertion of the conductor 82 and the rotational speed of the same. Consequently, a braking force according to the force acts on the spool 3, which rotates integrally with the moving element 80. As a result, excessive rotation of the spool 3 is prevented, thus inhibiting occurrence of a backlash phenomenon.

To adjust the braking force applied by the antibacklash mechanism 20, the adjustment operation portion 41 is rotated by such an amount that desired braking force is obtained, in a predetermined direction while a finger of the hand gripping the reel is pressed against the concave 65 formed in the exterior surface of the adjustment operation portion 41. As a result, the gear 71 attached to the adjustment operation portion 41 rotates, and the magnet holder 70 meshing with the gear 71 also rotates. Further, the outer magnet 75 fixed to the magnet holder 70 rotates with respect to the inner magnet 74. Consequently, a change arises between the polarity of the outer magnet 75 and that of the inner magnet 74, the magnets opposing each other, thereby changing the magnitude of magnetic field in the annular space defined between the magnets 74 and 75. Thus, braking force is adjusted to a desired level.

When the adjustment operation portion 41 is rotated, the spherical portion 66 provided on the part of the support portion 40 comes into repeated collision with each of the recess 64 formed in the interior surface of the adjustment operation portion 41, thereby generating a clicking sound. When the spherical portion 66 is engaged with a corresponding recess 64 in a position at which the adjustment operation portion 41 is rotated by a predetermined amount, the adjustment operation portion 41 attains a predetermined relative rotational position with respect to the support portion 40; that is, the outer magnet 75 attains a predetermined relative rotational position with respect to the inner magnet 74.

As has been described, in connection with the double bearing type fishing reel 1 according to the present embodiment, an area of the left side plate 1a which can be gripped and held by a hand also doubles as the adjustment operation portion 41 of the antibacklash mechanism 20. More specifically, the exterior surface of the adjustment operation portion 41 is substantially flush with the exterior surface of the left side plate 1a. The left side plate 1a, including the adjustment operation portion 41, assumes a smooth geometry not having a part projecting from the exterior surface of the adjustment operation portion. When an angler grips and holds the reel 1 with the palm, the angler obtains no unusual feeling in the hands. Further, there can be prevented pain in the hand, which would otherwise be caused as a result of use of such a reel for several hours. If the adjustment operation portion 41 does not project from the left side plate 1a of the reel main body, there is obviated a possibility of the angler erroneously actuating the adjustment operation portion 41 when gripping and holding the reel 1. Therefore, there can be prevented occurrence of a problem which would otherwise result from an inadvertent change in braking force.

First, according to the present embodiment, substantially the entire of exterior surface of the left side plate 1a (i.e., the major exterior surface) acts as a rotatable adjustment operation portion 41. Second, the left side plate 1a having the adjustment operation portion 41 constitutes a circle when viewed from the side, and the adjustment operation portion 41 is disposed concentrically with the reel main body. Third, the above-described erroneous-operation prevention geometry obviates a necessity of imparting retaining capability to the braking force adjustment portion. Hence, the antibacklash mechanism 20 is easy to operate and requires only light operation force.

In the present embodiment, the entirety of the left side plate 1a, including the adjustment operation portion 41, smoothly bulges in a spherical form toward the side of the reel main body. Hence, the reel easily fits the palm, thus enabling the angler to grip the reel 1 without fail. Consequently, the angler becomes able to more easily handle the reel 1 with elaborate action.

As has been described, the present invention enables provision of a double bearing type fishing reel equipped with an antibacklash mechanism which provides no unusual feeling in the hands when an angler grips and holds a reel main body, involves light operation force for a braking force adjustment portion, and has an antibacklash device having a small possibility of occurrence of erroneous operation.

What is claimed is:

1. A double bearing type fishing reel comprising:
a reel main body including side plates opposed each other;
a spool, for winding a fishing line thereon, rotatably supported between the side plates; and
an antibacklash mechanism for applying braking force to rotation of the spool for preventing excessive rotation of the spool in a direction in which the fishing line is paid out,
wherein a portion of one of the side plates, which can be at least gripped and held by a hand, functions as an adjustment operation portion for adjusting the braking force applied by the antibacklash mechanism.

2. The double bearing type fishing reel according to claim 1, wherein
an exterior surface of the adjustment operation portion is substantially flush with an exterior surface of the other portion of the one of the side plates, and
the one of the side plates including the adjustment operation portion has a smooth shape not having any portion projecting from the exterior surface of the one of the side plate.

3. The double bearing type fishing reel according to claim 2, wherein the entirety of the one of the side plates including the adjustment operation portion has a spherical shape bulging in a rotating axis direction of the spool.

4. The double bearing type fishing reel according to claim 1, wherein the side plate having the adjustment operation portion is a circular shape in view from the rotating axis direction, and the adjustment operation portion is located substantially concentrically with the reel main body.

5. The double bearing type fishing reel according to claim 1, wherein the one of the side plates includes the adjustment operation portion and a support portion for supporting the spool, the adjustment operation being capable of rotating with respect to the support portion for adjusting the braking force.
